(19) United States
(12) Patent Application Publication
(10) Pub. No.: US 2010/0018796 A1
(43) Pub. Date: Jan. 28, 2010

(54) Apparatus for controlling a power-assisted steering gear in response to vehicle conditions

(75) Inventor: Philip S. Peterson, Monticello, IN (US)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Automotive U.S. LLC

(21) Appl. No.: 12/220,103

(22) Filed: Jul. 22, 2008

(51) Int. Cl. B62D 5/06

(52) U.S. Cl. 180/422

(57) ABSTRACT

An apparatus (10) for helping to turn steerable wheels (12) of a vehicle comprises a hydraulic power-assisted steering gear (16) having an open center control valve (44). A variable displacement pump (110) supplies the steering gear (16) with hydraulic fluid. A controller (104) controls the pump (84). The controller (104) sends a control signal to the pump (110) to control the displacement of the pump (110).

### TECHNICAL FIELD

The present invention relates to an apparatus for controlling a power-assisted steering gear having an open center control valve in response to vehicle conditions.

### BACKGROUND OF THE INVENTION

A conventional hydraulic power-assisted steering system includes a steering gear having a hydraulic motor. A fluid pump draws hydraulic fluid from a fluid reservoir and supplies the hydraulic fluid to the steering gear. Typically, the engine of the vehicle powers the pump to supply hydraulic fluid from a fluid reservoir to the steering gear. The steering gear includes a closed center control valve. The control valve is responsive to steering inputs for directing hydraulic fluid to the hydraulic motor. The hydraulic motor is operatively connected to the steerable wheels of the vehicle and, when actuated, helps to turn the steerable wheels. As the speed of the vehicle increases, the need for power-assisted steering decreases. The conventional hydraulic power-assisted steering system may control the speed of the pump in response to the vehicle speed.

### SUMMARY OF THE INVENTION

The present invention relates to an apparatus for helping to turn steerable wheels of a vehicle. The apparatus comprises a hydraulic power-assisted steering gear having an open center control valve. A variable displacement pump supplies the steering gear with hydraulic fluid. A controller controls the pump. The controller sends a control signal to the pump to control the displacement of the pump.

### BRIEF DESCRIPTION OF THE DRAWINGS

The foregoing and other features of the present invention will become apparent to those skilled in the art to which the present invention relates upon reading the following description with reference to the accompanying drawings, in which:

FIG. 1 is a schematic illustration of an apparatus constructed in accordance with a first embodiment of the present invention;

FIG. 2 is a schematic illustration of an apparatus constructed in accordance with a second embodiment of the present invention; and

FIG. 3 is a schematic illustration of an apparatus constructed in accordance with a third embodiment of the present invention.

### DETAILED DESCRIPTION OF THE INVENTION

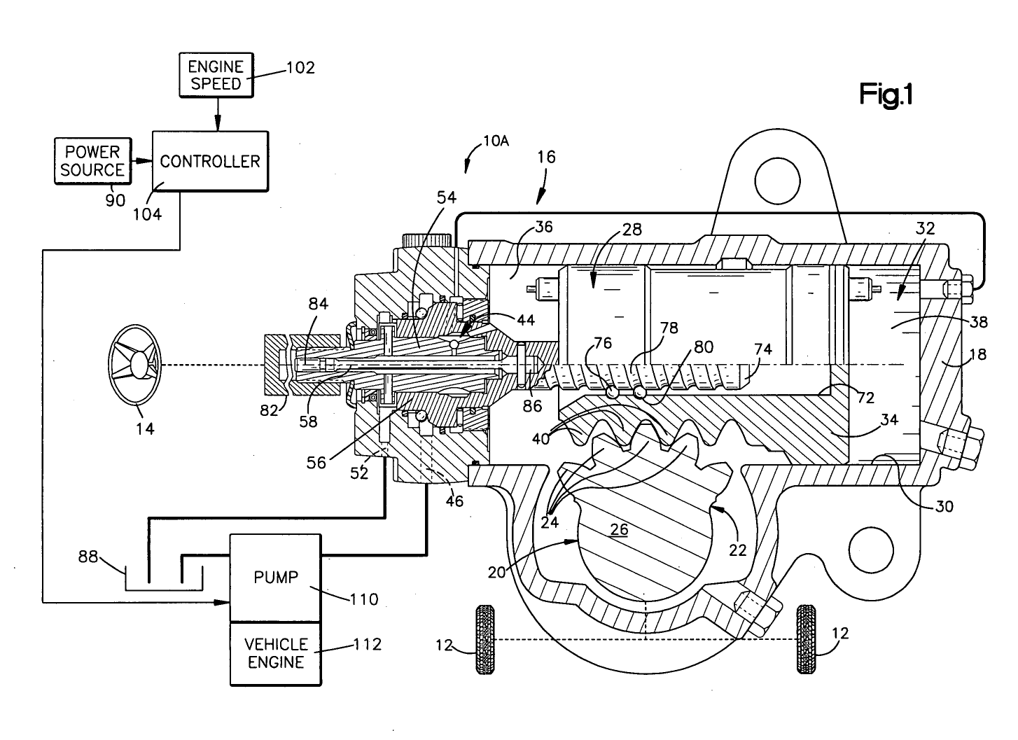

FIG. 1 illustrates an apparatus 10A constructed in accordance with the present invention. The apparatus 10A helps to turn steerable wheels 12 of a vehicle in response to rotation of a hand wheel 14 of the vehicle.

The apparatus 10A includes a hydraulic power assisted steering gear 16. The steering gear 16 illustrated in FIG. 1 is an integral hydraulic power assisted steering gear. Other hydraulic power assisted steering gears are contemplated by this invention, for example, the steering gear may be a rack and pinion steering gear.

The steering gear 16 includes a housing 18 and a drive mechanism 20. The drive mechanism 20 is moved in response to rotation of the hand wheel 14 of the vehicle. The motion of the drive mechanism 20 results in a turning of the steerable wheels 12 of the vehicle.

The drive mechanism 20 includes a sector gear 22 having a plurality of teeth 24. The sector gear 22 is fixed on an output shaft 26 that extends outwardly through an opening in the housing 18. The output shaft 26 is typically connected to a pitman arm (not shown) that is connected to the steering linkage of the vehicle. The dashed lines between the output shaft 26 and the steerable wheels 12 in FIG. 1 schematically represent the pitman arm and steering linkage. Thus, as the sector gear 22 rotates, the output shaft 26 is rotated to operate the steering linkage. As a result, the steerable wheels 12 of the vehicle are turned.

The steering gear 16 further includes a hydraulic motor 28 for moving the drive mechanism 20. The hydraulic motor 28 is located within the housing 18 of the steering gear 16. The housing 18 of the steering gear 16 has an inner cylindrical surface 30 defining a chamber 32. A piston 34 is located within the chamber 32 and divides the chamber into opposite chamber portions 36 and 38. One chamber portion 36 is located on a first side of the piston 34 and the other chamber portion 38 is located on a second opposite side of the piston. The piston 34 creates a seal between the respective chamber portions 36 and 38 and is capable of axial movement within the chamber 32. This axial movement of the piston 34 results in an increase in volume of one chamber portion, e.g., 36, and a corresponding decrease in volume of the other chamber portion, e.g., 38.

A series of rack teeth 40 is formed on the periphery of the piston 34. The rack teeth 40 act as an output for the hydraulic motor 28 and mesh with the teeth 24 formed on the sector gear 22 of the drive mechanism 20.

A control valve 44 directs the flow of hydraulic fluid to the hydraulic motor 28. The control valve 44 is located within the housing 18 of the steering gear 16. An inlet 46 provides fluid communication to the control valve 44 and an outlet 52 provides fluid communication away from the control valve.

The control valve 44 is of the open center type. Therefore, when the control valve 44 is in an initial or unactuated, neutral position, fluid flow is directed to the outlet 52. The control valve 44 includes a valve core portion 54 and a valve sleeve portion 56 that are connected together through a torsion bar 58. The control valve 44 directs fluid to an appropriate chamber portion 36 or 38 of the hydraulic motor 28. The flow of hydraulic fluid toward one of the chamber portions 36 or 38 increases the pressure within that chamber portion. When the pressure of one chamber portion, e.g., 36, increases relative to the pressure of the other chamber portion, e.g., 38, the piston 34 moves axially and the volume of the higher-pressure chamber portion increases. The volume of the higher-pressure chamber portion, e.g., 36, increases until the pressure within the chamber portions 36 and 38 equalizes.

As the volume of one chamber portion, e.g., 36, increases, the volume of the other chamber portion, e.g., 38, decreases. The decreasing chamber portion, e.g., 38, is vented to allow a portion of the fluid contained in the decreasing chamber portion to escape. The escaping fluid exits the housing 18 of the steering gear 16 via the outlet 52.

The piston 34 of the hydraulic motor 28 contains a bore 72, partially shown in FIG. 1, which is open toward the control valve 44. The valve sleeve portion 56 and a follow-up member 74 collectively form an integral one-piece unit that is supported for rotation relative to the piston 34 by a plurality of balls 76. The outer periphery 78 of the follow-up member 74 is threaded. The plurality of balls 76 interconnects the threaded outer periphery 78 of the follow-up member 74 with an internal thread 80 formed in the bore 72 of the piston 34. As a result of the interconnecting plurality of balls 76, axial movement of the piston 34 causes the follow-up member 74 and the valve sleeve portion 56 to rotate. The rotation of the follow-up member 74 and the valve sleeve portion 56 returns the control valve 44 to the neutral position.

The valve core portion 54 of the control valve 44 is fixedly connected to an input shaft 82. As shown schematically by dashed lines in FIG. 1, the input shaft 82 is connected to the hand wheel 14 of the vehicle. Rotation of the hand wheel 14 results in rotation of the input shaft 82 and rotation of the valve core 52.

The torsion bar 84 of the steering gear 16 has first and second ends 84 and 86, respectively. The first end 84 of the torsion bar 58 is fixed relative to the input shaft 82 and the valve core portion 54 of the control valve 44. The second end 86 of the torsion bar 58 is fixed relative to the valve sleeve portion 56 of the control valve 44 and the follow-up member 74.

When the resistance to turning of the steerable wheels 12 of the vehicle is below a predetermined amount, rotation of the hand wheel 14 is transferred through the torsion bar 58 and causes rotation of the follow-up member 74. As a result, the control valve 44 remains in the neutral position. Rotation of the follow-up member 74 causes movement of the piston 34 and results in turning of the steerable wheels 12.

The control valve 44, when in the neutral position, directs the flow of hydraulic fluid to the outlet 52 and away from the control valve. Thus, the flow of hydraulic fluid is not directed to one of the chamber portions 36 or 38 of the hydraulic motor 28. Accordingly, no power-steering assistance is provided by the steering gear 16.

When resistance to turning the steerable wheels 12 of the vehicle is at or above the predetermined amount, rotation of the follow-up member 74 is resisted. As a result, rotation of the hand wheel 14 rotates the first end 84 of the torsion bar 58 relative to the second end 86 of the torsion bar. The rotation of the first end 84 of the torsion bar 58 relative to the second end 86 of the torsion bar results in torsion or twisting across the torsion bar. As a result of torsion across the torsion bar 58, the valve core portion 54 of the control valve 44 rotates relative to the valve sleeve portion 56 of the control valve and the control valve 44 directs fluid toward one of the chamber portions 36 or 38 of the hydraulic motor 28.

As discussed above, when fluid is directed toward one of the chamber portions 36 or 38, the piston 34 moves within the chamber 32. Movement of the piston 34 results in turning of the steerable wheels 12 of the vehicle, as well as, rotation of the follow-up member 74. As discussed above, rotation of the follow-up member 74 rotates the valve sleeve portion 56 until the control valve 44 is again in the neutral position. When the control valve 44 is in the neutral position, the torsion across the torsion bar 58 is removed and the first end 84 of the torsion bar is no longer rotated or twisted relative to the second end 86 of the torsion bar. Thus, the control valve 44 directs the flow of hydraulic fluid back to the outlet 52 and not to one of the chamber portions 36 or 38 of the hydraulic motor 28.

The apparatus 10A includes a pump 110 that is in fluid communication with the steering gear 16 for supplying hydraulic fluid to the steering gear. The pump 110 draws hydraulic fluid from a fluid reservoir 88 and supplies the hydraulic fluid to the inlet 46 of the steering gear 16. The pump 110 is operatively connected to the engine 112 of the vehicle and is driven by the engine of the vehicle.

The pump 110 is a variable displacement pump. The displacement of the pump 110 is adjusted to provide a desired amount of fluid flow to the steering gear 16. The displacement of the pump 110 may be adjusted to provide only the amount of fluid flow required by the steering gear 16. The displacement of the pump 110 is varied in response to the speed of the pump shaft (not shown) driven by the vehicle engine 112. The displacement of the pump 110 can be varied, for example, by adjusting the pump swash plate (not shown). Those skilled in the art will recognize that the swash plate could be adjusted mechanically and/or electronically, including, but not limited to, the use of a solenoid.

As the speed of the vehicle engine 112 increases, the speed of the pump shaft likewise increases. The increased vehicle speed decreases the resistance to turning of the steerable wheels 12. The demand for power-assisted steering, therefore, also decreases. If the pump displacement is maintained at a constant value as the vehicle speed increases, the increased pump shaft speed results in an increased fluid flow rate through the pump 110. This results in an increased fluid flow rate to the steering gear 16. Since the fluid flow rate has increased and the demand for power-assisted steering has decreased, the steering gear 16 is providing an excess of power-assisted steering beyond that which is required. Accordingly, fixed displacement pumps use a flow control valve or relief valve to remove the excess fluid pressure.

By using a variable displacement pump 110, the fluid flow rate from the pump 110 to the steering gear 16 can be increased or decreased. In particular, as the speed of the vehicle engine 112 changes, the displacement of the pump 110 can be altered to provide a desired fluid flow rate through the pump and to the steering gear 16. This desired flow rate may provide only the amount of power-assisted steering as the particular circumstances require and prevent excess pressure buildup. For example, it may be desirous to maintain a particular constant fluid flow rate to the steering gear 16 for a particular range of vehicle engine speeds. Alternatively, it may be desirous to provide a linear or stepped correlation between vehicle engine speed and the fluid flow rate from the pump 110 to the steering gear 16. Since the use of a variable displacement pump 110 provides only the desired amount of power-assisted steering, the need for a pump control valve or relief valve, as used with a fixed displacement pump, is alleviated. Thus, the variable displacement pump 110 of the present invention requires less power and produces less heat than a fixed displacement pump. Furthermore, due to its flexibility in output, the same variable displacement pump can be used interchangeably in a number of alternative configurations and applications.

The apparatus 10A also includes a vehicle condition sensor 102 and a controller 104. Preferably, the vehicle condition sensor comprises an engine speed sensor 102 electrically connected to the controller 104. The engine speed sensor 102 senses the speed of the vehicle engine 112 and generates an electrical signal indicative of the speed.

The controller 104 uses known algorithms to correlate the signal from the engine speed sensor 102 with a predetermined pump displacement value. Each pump displacement value is factory calibrated to produce a pump flow rate for a given pump shaft speed—here determined by the speed of the engine 112. The controller 104 then generates a control signal to adjust the swash plate of the pump 110, thereby obtaining the desired pump displacement value to supply hydraulic fluid to the steering gear 16 at the desired flow rate. Accordingly, the controller 104 can adjust the swash plate of the pump 110 over a range of engine speeds to maintain the desired flow rate to the steering gear 16, thereby providing only that amount of power-assisted steering as is necessary throughout the range of engine speeds.

The process performed by the controller 104 of FIG. 1 can be described as follows. The controller 104 first monitors the engine speed. The controller 104 then analyzes the signal received from the engine speed sensor 102 and generates the control signal to adjust the swash plate of the pump 110, thereby supplying a desired fluid flow rate to the steering gear 16. The controller 104 then monitors the engine speed again and the process repeats.

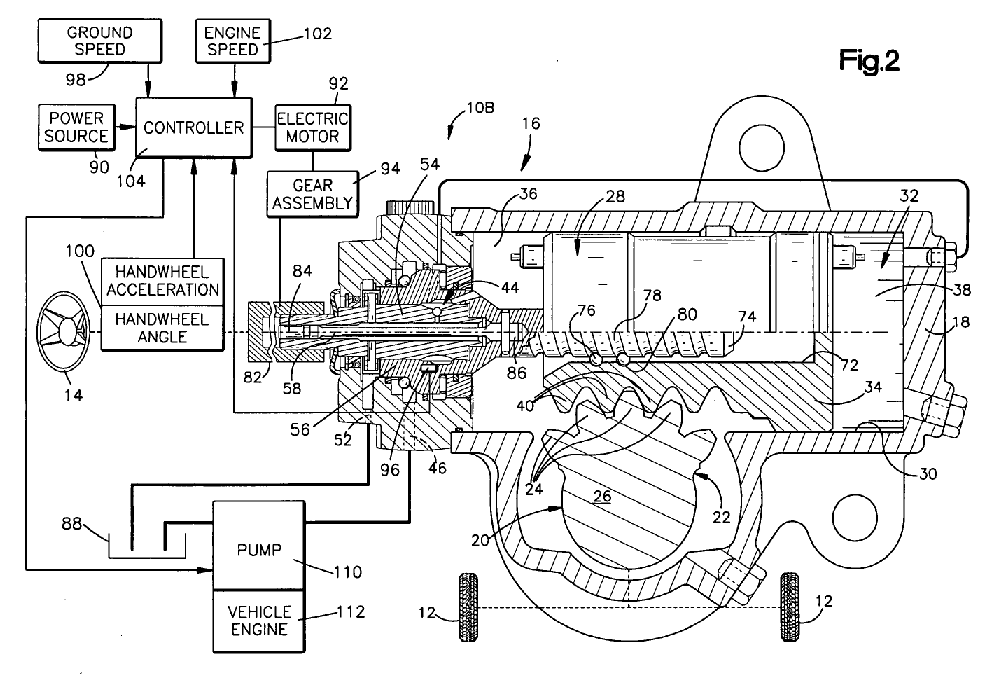

FIG. 2 illustrates an apparatus 10B constructed in accordance with a second embodiment of the present invention. Structures of FIG. 2 that are the same as or similar to structures of FIG. 1 are numbered using the same reference numbers and are not discussed in detail with regard to FIG. 2. Only the differences between the apparatus 10A of FIG. 1 and the apparatus 10B of FIG. 2 are discussed in detail below.

In contrast to the apparatus 10A of FIG. 1, the apparatus 10B of FIG. 2 includes a steering demand sensor 96, a plurality of vehicle condition sensors 98, 100 and 102 and a controller 104. Preferably, the vehicle condition sensors include a ground speed sensor 98, a hand wheel rotation sensor 100, and an engine speed sensor 102. Each sensor 96, 98, 100 and 102 is electrically connected to the controller 104.

The steering demand sensor 96 may include a column torque sensor 96 that senses column torque and, therefore, a steering demand. The column torque sensor 96 generates an electrical signal indicative of the column torque. Column torque is related to the torsion across the torsion bar 58 and the material properties of the torsion bar. The column toque sensor 96 may measure the rotational movement of the first end 84 of the torsion bar 58 relative to the second end 86 of the torsion bar. The movement of the valve core portion 54 relative to the valve sleeve portion 56 alternatively may be measured for indicating the relative rotation between the first end 84 and the second end 86 of the torsion bar 58. The steering demand sensor 96 may sense the steering demand in any desired manner. It is contemplated that the steering demand sensor 96 may be connected to the hand wheel 14.

The ground speed sensor 98 senses the ground speed of the vehicle and generates an electrical signal indicative of the sensed ground speed. The hand wheel rotation sensor 100 senses the magnitude, rate, and acceleration of rotation of the vehicle hand wheel 14 and generates electrical signals indicative of these parameters. The hand wheel rotation sensor 100 may also sense the steering demand. The hand wheel rotation magnitude is the angle of rotation of the hand wheel 14 relative to a straight ahead position of the hand wheel. Rotation of the hand wheel 14 in a first direction may be designated as a positive value and rotation of the hand wheel 14 in a second direction, opposite the first direction, may be designated as a negative value. The hand wheel rotation sensor 100, or the controller 104, may determine the rate of rotation of the hand wheel 14 by taking a time differential of the magnitude and may determine the hand wheel acceleration by taking a time differential of the rate of rotation. The engine speed sensor 102 senses the speed of the vehicle engine 112 and generates an electrical signal indicative of the speed.

The controller 104 receives the signals generated by the ground speed sensor 98, the hand wheel rotation sensor 100, and the engine speed sensor 102. Additionally, the controller 104 receives the column torque signal from the steering demand sensor 96. The controller 104 analyzes the respective signals using a known algorithm and generates a control signal for controlling an electric motor 92. The electric motor 92 is controlled for actuating the steering gear 16 so as to provide a predetermined resistance to rotation of the hand wheel 14.

The electric motor 92 may be of any conventional design. The electric motor 92 receives electric power from the power source 90. An output shaft (not shown) of the electric motor 92 is connected to the input shaft 82 of the steering gear 16. Preferably, a gear assembly 94 is used to connect the output shaft of the electric motor 92 to the input shaft 82 of the steering gear 16. The electric motor 92 may connect the hand wheel 14 to the input shaft 82. When the electric motor 92 receives electric power, the output shaft of the electric motor, through the gear assembly 94, rotates the input shaft 82 of the steering gear 16. Thus, the electric motor 92 is said to be “in series connection” with the hydraulic motor 28. As a result, the electric motor 92 assists the operator in rotating the input shaft 82 of the steering gear 18.

Additionally, the controller 104 uses known algorithms to correlate the signals from the steering demand sensor 96, the ground speed sensor 98 and the engine speed sensor 102 with a predetermined pump displacement value. Similar to the controller in the embodiment of FIG. 1, the controller 104 of FIG. 2 then generates a control signal to adjust the swash plate of the pump 110, thereby obtaining the pump displacement value to supply hydraulic fluid to the steering gear 16 at the desired flow rate. Accordingly, the controller 104 can adjust the swash plate of the pump 110 over a range of engine speeds to maintain the desired flow rate to the steering gear 16, thereby providing only that amount of power-assisted steering as is necessary throughout the range of engine speeds.

By additionally taking into account the steering demand, the controller 104 can control the fluid flow rate to the steering gear 16 in situations where monitoring the engine speed alone may not be sufficient. In particular, when there is no steering demand, e.g. no column torque, there is no demand for power-assisted steering. Thus, regardless of the signals generated by the ground speed sensor 98 and/or the engine speed sensor 102, the controller 104 can adjust the swash plate of the pump 110 to reduce the fluid flow rate to the steering gear 16 to a minimal amount. This improves the efficiency of the apparatus 10B and results in a reduction in power requirements and heat produced.

Furthermore, by taking into account the ground speed of the vehicle, the controller 104 is capable of more accurately adjusting the fluid flow rate to the steering gear 16 when the engine speed may be high but the ground speed is at or near zero. This occurs when the vehicle is stopped or parked and there is no rotation of the hand-wheel 14, but the engine is still running and therefore generating an engine speed signal from the engine speed sensor 102. In such a case, the demand for power-assisted steering is low. Therefore, the controller 104 can recognize that the vehicle is not moving and adjust the swash plate of the pump 110 to reduce the fluid flow rate to the steering gear 16 to a minimal amount. This feature also improves the efficiency of the apparatus 10B and results in a reduction in power requirements and heat produced.

The process performed by the controller 104 of FIG. 2 can be described as follows. The controller 104 first monitors the handwheel rotation, the engine speed, the ground speed of the vehicle and the steering demand. The controller 104 then analyzes these monitored signals and outputs the control signal to control the electric motor 92 and the control signal to adjust the swash plate of the pump 110, thereby supplying a desired fluid flow rate to the steering gear 16. The controller 104 then monitors the handwheel rotation, engine speed, ground speed and column torque again and the process repeats.

Although the embodiment of FIG. 1 does not illustrate the use of the electric motor 92, gear assembly 94 and torque sensor 96 shown in FIG. 2, those in the art will appreciate that any or all of these features may be used with the apparatus 10A of FIG. 1 in accordance with the present invention. Those skilled in the art will also appreciate that the controller 104 in FIG. 1 may be responsive to the column torque sensor 96 and the engine speed sensor 102 to generate a control signal for controlling the electric motor 92 as previously described.

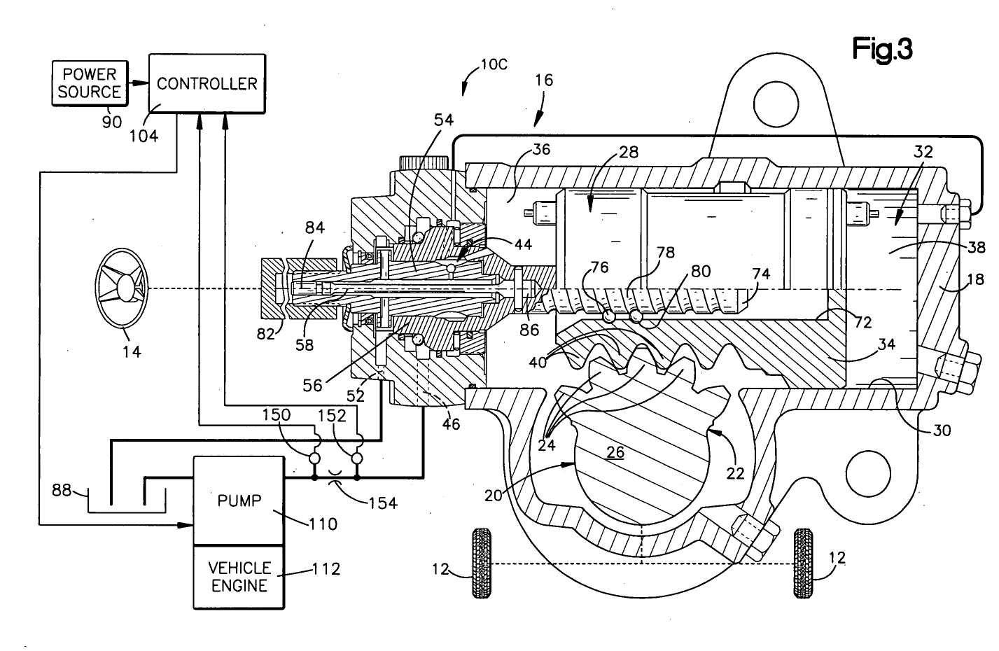

FIG. 3 illustrates an apparatus 10C constructed in accordance with a third embodiment of the present invention. Structures of FIG. 3 that are the same as or similar to structures of FIG. 1 are numbered using the same reference numbers and are not discussed in detail with regard to FIG. 3. Only the differences between the apparatus 10A of FIG. 1 and the apparatus 10C of FIG. 3 are discussed in detail below.

The apparatus 10C of FIG. 3 relies on a plurality of pressure sensors 150, 152 to control the fluid flow rate through the pump. In particular, the sensors 150, 152 are configured to measure the pressure drop across an orifice 154 downstream from the pump 110. The first pressure sensor 150 and the second pressure sensor 152 are located on either side of the orifice 154. Each sensor 150, 152 is electrically connected to the controller 104.

The first pressure sensor 150 senses fluid pressure at a first location between the pump 110 and the orifice 154 and generates an electrical signal indicative of the sensed fluid pressure at the first location. The second pressure sensor 152 senses fluid pressure at a second location between the orifice 154 and the steering gear 16 and generates an electrical signal indicative of the sensed fluid pressure at the second location.

The controller 104 receives the signals generated by the first pressure sensor 150 and the second pressure sensor 152. The controller 104 uses known algorithms to correlate the signals from the first pressure sensor 150 and the second pressure sensor 152 with a predetermined pump displacement value. Similar to the controller in the embodiment of FIG. 1, the controller 104 of FIG. 3 then generates a control signal to adjust the swash plate of the pump 110, thereby obtaining the pump displacement value to supply hydraulic fluid to the steering gear 16 at the desired flow rate.

By monitoring the fluid pressure at the first and second pressure sensors 150, 152, the controller 104 can adjust the swash plate of the pump 110 to maintain a constant pressure drop across the orifice 154. A change in the demand for power-assisted steering will cause the pressure drop across the orifice to change.

If the demand increases, fluid pressure at the second pressure sensor 152 will decrease relative to the fluid pressure at the first pressure sensor 150. To maintain a constant pressure drop across the orifice 154, the controller 104 will adjust the swash plate to increase the fluid flow through the pump 110 and to the steering gear 16. Likewise, if the demand decreases, fluid pressure at the second pressure sensor 152 will increase relative to the fluid pressure at the first pressure sensor 150. To maintain a constant pressure drop across the orifice 154, the controller 104 will adjust the swash plate to decrease the fluid flow from the pump 110 and to the steering gear 16. Accordingly, the pressure sensors 150, 152 allow the controller 104 to control the fluid flow rate of the pump 110 such that a constant pressure drop is maintained across the orifice 154 to provide only that amount of power-assisted steering that is demanded. This improves the efficiency of the apparatus 10C and results in a reduction in power requirements and heat produced.

The process performed by the controller 104 of FIG. 3 can be described as follows. The controller 104 monitors the first pressure sensor 150 and the second pressure sensor 152. The controller 104 then analyzes these monitored signals and outputs the control signal to adjust the swash plate of the pump 110, thereby supplying a desired fluid flow rate to the steering gear 16. The controller 104 then monitors the first pressure sensor 150 and the second pressure sensor 152 again and the process repeats.

The controller 104 may control a pressure relief valve (not shown) between the pump 110 and the steering gear 16. If the pressure sensed by the second pressure sensor 152 is above a predetermined pressure, the controller 104 may actuate the pressure relief valve electronically to reduce the pressure between the pump 110 and the steering gear 16.

Although the embodiment of FIG. 3 does not illustrate the use of the electric motor 92, gear assembly 94 and torque sensor 96 shown in FIG. 2, those in the art will appreciate that any or all of these features may be used with the apparatus 10C of FIG. 3 in accordance with the present invention. Those skilled in the art will also appreciate that the controller 104 in FIG. 3 may be responsive to the first pressure sensor 150, the second pressure sensor 152 and the column torque sensor 96 to generate a control signal for controlling the electric motor 92 as previously described.

From the above description of the invention, those skilled in the art will perceive improvements, changes and modifications. Such improvements, changes and modifications within the skill of the art are intended to be covered by the appended claims.

Having described the invention, we claim the following:

1. An apparatus for helping to turn steerable wheels of a vehicle, the apparatus comprising:
a hydraulic power-assisted steering gear having an open center control valve;
a variable displacement pump for supplying the steering gear with hydraulic fluid; and
a controller for controlling the pump, the controller sending a control signal to the pump to control the displacement of the pump.

2. The apparatus of claim 1, further comprising an electric motor for actuating the steering gear.

3. The apparatus of claim 2, wherein the electric motor is responsive to rotation of a hand wheel of the vehicle for actuating the steering gear, the controller controlling the electric motor to provide a predetermined resistance to rotation of the hand wheel.

4. The apparatus of claim 2, wherein the controller controls the electric motor to provide a predetermined resistance to rotation of the hand wheel, the electric motor being operatively connected to the steering gear to actuate the open center control valve.

5. The apparatus of claim 4, further comprising a steering demand sensor operatively connected to a hand wheel for sensing the steering demand and for providing a signal indicative of the steering demand, the controller being responsive to the signal indicative of the steering demand for controlling the displacement of the pump.

6. The apparatus of claim 4 wherein the steering gear includes a torsion bar, a column torque sensor operatively connected to the torsion bar for sensing the column torque of the torsion bar and for providing a signal indicative of the column torque of the torsion bar, wherein the controller is responsive to the signal indicative of the column torque of the torsion bar for controlling the displacement of the pump.

7. The apparatus of claim 5 further comprising a ground speed sensor for sensing vehicle ground speed and for providing a ground speed signal, the control signal of the controller being responsive to the ground speed signal and the steering demand signal to control the displacement of the pump.

8. The apparatus of claim 1 further comprising an engine speed sensor for sensing vehicle engine speed and for providing an engine speed signal, the controller being responsive to the engine speed signal for controlling the displacement of the pump.

9. The apparatus of claim 1, wherein the controller sends the control signal to the pump to maintain a desired fluid flow rate to the steering gear over a range of vehicle engine speeds.

10. The apparatus of claim 1, wherein the vehicle engine is operatively connected to the pump for driving the pump to supply hydraulic fluid to the steering gear.

11. The apparatus of claim 1, wherein the steering gear includes at least one chamber, the control valve being actuated to direct the fluid from the pump to the chamber of the steering gear.

12. The apparatus of claim 11, further including a torsion bar, wherein the control valve includes a valve core portion and a valve sleeve portion that are connected together through the torsion bar.

13. The apparatus of claim 12, wherein when the resistance to turning the steerable wheels is above a predetermined amount, the torsion bar causes the valve core portion to rotate relative to the valve sleeve portion to cause the control valve to direct the fluid from the pump to the chamber of the steering gear.

14. The apparatus of claim 1, wherein the control signal adjusts a swash plate of the pump to obtain a predetermined pump displacement value, the pump displacement value providing a desired fluid flow rate to the steering gear.

15. The apparatus of claim 1, further comprising:
a first pressure sensor for sensing fluid pressure at a first location between the pump and the steering gear and for providing a first fluid pressure signal; and
a second pressure sensor for sensing fluid pressure at a second location between the pump and the steering gear and for providing a second fluid pressure signal;
wherein the controller is responsive to the first and second fluid pressure signals for controlling the pump, the controller sending the control signal to control the displacement of the pump.

16. The apparatus of claim 15, wherein the controller sends the control signal to the pump to maintain a desired fluid flow rate to the steering gear over a range of vehicle engine speeds.

17. The apparatus of claim 14, wherein a vehicle engine is operatively connected to the pump for driving the pump to supply hydraulic fluid to the steering gear.
